(19) United States
(12) Patent Application Publication
(10) Pub. No.: US 2026/0322266 A1
(43) Pub. Date: Oct. 15, 2026

(54) BUCK CONVERTER, METHOD FOR OPERATING THE SAME AND ELECTRONIC DEVICE INCLUDING THE SAME

(71) Applicant: SAMSUNG ELECTRONICS CO., LTD., Suwon-si (KR)

(72) Inventors: Young Jong KIM, Suwon-si (KR); Seung Kon KONG, Suwon-si (KR); Da Han YU, Suwon-si (KR); Seong Hoon JOO, Suwon-si (KR)

(73) Assignee: SAMSUNG ELECTRONICS CO., LTD., Suwon-si (KR)

(21) Appl. No.: 19/637,347

(22) Filed: Apr. 2, 2026

(30) Foreign Application Priority Data
Apr. 10, 2025 (KR) 10-2025-0046940

(51) Int. Cl. H02M 3/158; H02M 1/00

(52) U.S. Cl. CPC H02M 3/158; H02M 1/0025

(57) ABSTRACT

A buck converter generating an output voltage by stepping down an input voltage is provided. The buck converter includes an output circuit including an inductor and a switch controller configured to control a current of the inductor based on a pulse width modulation signal, a comparator configured to output an error voltage based on a reference voltage and a feedback voltage, an integrator circuit configured to receive a sensing voltage generated at an end of the inductor and outputting an integral output based on the sensing voltage, an adder circuit configured to receive the error voltage and outputting an addition output based on the error voltage, the feedback voltage, and the reference voltage, and a controller configured to output the pulse width modulation signal by comparing the integral output with the addition output.

### CROSS-REFERENCE TO RELATED APPLICATION

This application claims priority under 35 U.S.C. § 119 to and the benefit of Korean Patent Application No. 10-2025-0046940, filed on Apr. 10, 2025, in the Korean Intellectual Property Office, the disclosure of which is incorporated herein by reference in its entirety.

### BACKGROUND

### 1. Field

The disclosure relates to a buck converter, a method for operating the buck converter, and an electronic device including the buck converter.

### 2. Description of the Related Art

A direct current-to-direct current (DC-DC) converter is a converter that converts a first-level DC voltage into a second-level DC voltage. The DC-DC converter is a power source that supplies power (e.g., voltage and current) to various Intellectual Property (IP) blocks of an electronic device or a charging power source for a battery of the electronic device. Many mobile electronic devices (e.g., Internet of Things (IoT) devices, tablet PCs, smartphones, wearable devices, etc.) may receive voltage and current from a battery and operate using the voltage converted by the DC-DC converter.

The DC-DC converter may be implemented as a buck converter, a boost converter, a buck-boost converter, etc. In particular, the buck converter may perform a voltage conversion operation by either fixing a peak value of a current of an inductor element or fixing a length of a period at which an input voltage is provided to the inductor element. However, a voltage drop may occur in an output voltage supplied to the IP block by the buck converter in a transient state in which a magnitude of a load current in the IP block varies. A voltage drop occurring in the transient state may cause a malfunction of the IP block.

### SUMMARY

The disclosure provides a buck converter capable of supplying a stable output voltage.

The disclosure provides a method for operating a buck converter capable of supplying a stable output voltage.

The disclosure provides an electronic device to which a buck converter capable of supplying a stable output voltage is applied.

According to some embodiments of the disclosure, there is provided a buck converter may include an output circuit including an inductor and a switch controller configured to control a current of the inductor based on a pulse width modulation signal, a comparator configured to output an error voltage based on a reference voltage and a feedback voltage, an integrator circuit configured to receive a sensing voltage generated at an end of the inductor and to output an integral output based on the sensing voltage, an adder circuit configured to receive the error voltage and to output an addition output based on the error voltage, the feedback voltage, and the reference voltage, and a controller configured to output the pulse width modulation signal by comparing the integral output with the addition output.

According to some embodiments of the disclosure, there is provided a method for operating a buck converter may include receiving a sensing voltage generated at an end of an inductor and providing a controller with an integral output based on the sensing voltage by an integrator circuit, receiving an error voltage and providing the controller with an addition output based on the error voltage, a feedback voltage and a reference voltage by an adder circuit, and comparing the integral output with the addition output by the controller to output a pulse width modulation signal.

According to some embodiments of disclosure, an electronic device may include a power supply device configured to output an input voltage, an integrated circuit including a buck converter configured to receive the input voltage and output an output voltage by stepping down the input voltage, and one or more IP blocks receiving the output voltage, wherein the buck converter includes an output circuit including an inductor and a switch controller configured to control a current of the inductor based on a pulse width modulation signal, a comparator configured to output an error voltage based on a reference voltage and a feedback voltage, an integrator circuit configured to receive a sensing voltage generated at an end of the inductor and output an integral output based on the sensing voltage, an adder circuit configured to receive the error voltage and output an addition output based on the error voltage, the feedback voltage, and the reference voltage, and a controller configured to output the pulse width modulation signal by comparing the integral output with the addition output.

The disclosure are not limited to those mentioned above. Additional aspects of the disclosure, which are not mentioned herein, will be clearly understood from the following description of the disclosure.

### BRIEF DESCRIPTION OF DRAWINGS

FIG. 1 is a block diagram illustrating an electronic device according to some embodiments.

FIG. 2 is a circuit diagram illustrating a buck converter according to some embodiments.

FIG. 3 is graphs illustrating a voltage drop occurring in a transient state.

FIG. 4 is an enlarged view of a partial region R of FIG. 3 in order to estimate a load current.

FIG. 5 is a circuit diagram illustrating a buck converter according to some embodiments.

FIG. 6 is a circuit diagram illustrating an integrator circuit of a buck converter according to some embodiments.

FIG. 7 is a circuit diagram illustrating an adder circuit of a buck converter according to some embodiments.

FIG. 8 is a flowchart illustrating a method for operating a buck converter of FIG. 5 according to some embodiments.

FIG. 9 is a flowchart illustrating a method for operating an integrator circuit according to some embodiments.

FIG. 10 is a flowchart illustrating a method for operating an adder circuit according to some embodiments.

FIG. 11 is a block diagram illustrating an electronic device to which a buck converter according to some embodiments is applied.

### DETAILED DESCRIPTION

In the specification, it will be understood that when an element (or region, layer, part, etc.) is referred to as being “on”, “connected to”, or “coupled to” another element, it can be directly on, connected to, or coupled to the other element, or one or more intervening elements may be present therebetween. In a similar sense, when an element (or region, layer, part, etc.) is described as “covering” another element, it can directly cover the other element, or one or more intervening elements may be present therebetween.

In the specification, when an element is “directly on,” “directly connected to,” or “directly coupled to” another element, there are no intervening elements present. For example, “directly on” may mean that two layers or two elements are disposed without an additional element such as an adhesion element therebetween.

As used herein, the expressions used in the singular such as “a,” “an,” and “the,” are intended to include the plural forms as well, unless the context clearly indicates otherwise.

As used herein, the term “and/or” includes any and all combinations of one or more of the associated listed items. For example, “A and/or B” may be understood to mean “A, B, or A and B.” As used herein, an expression “at least one of” preceding a list of elements modifies the entire list of the elements and does not modify the individual elements of the list. For example, an expression, “at least one of a, b, and c” and “at least one of a, b, or c” should be understood as including only a, only b, only c, both a and b, both a and c, both b and c, or all of a, b, and c.

In the specification, when an element is referred to as being “in contact” or “contacted” or the like to another element, the element may be in “electrical contact” or in “physical contact” with another element; or in “indirect contact” or in “direct contact” with another element.

Hereinafter, the embodiments according to the technical spirits of the disclosure will be described with reference to the accompanying drawings.

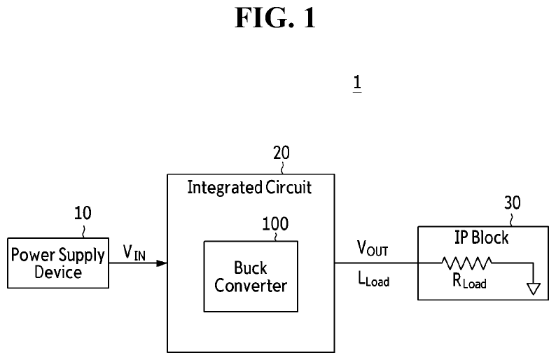

FIG. 1 is a block diagram illustrating an electronic device according to some embodiments.

Referring to FIG. 1, an electronic device 1 may include a power supply device 10, an integrated circuit (IC) 20, and an intellectual property (IP) block 30. For example, the integrated circuit 20 may be implemented as an integral output chip, and may be mounted on a printed circuit board. The integrated circuit 20 may be a power management integrated circuit (PMIC), but is not limited thereto. Also, the electronic device 1 may be a mobile device such as a smartphone, a tablet personal computer (PC), a cellular phone, a personal digital assistant (PDA), a laptop, a wearable device, a global positioning system (GPS), an e-book terminal, a digital broadcasting terminal, an MP3 player, and a digital camera. Furthermore, the electronic device 1 may be a device that performs Internet of Things (IoT) or a device included in an electric vehicle.

For example, the power supply device 10 may include a battery. The power supply device 10 may be embedded in the electronic device 1, but is not limited thereto, and may be positioned outside the electronic device 1 and connected to the electronic device 1. As another example, when the power supply device 10 is a battery, the power supply device 10 may be detachable from the electronic device 1. The IP block 30 may be chips or modules included in the electronic device 1, or may be a functional block or device configured to perform various functions. The power supply device 10 may provide an input voltage V_{IN} to the integrated circuit 20.

According to some embodiments, the integrated circuit 20 may include a buck converter 100. The buck converter 100 may receive the input voltage V_{IN} from the power supply device 10, and perform a voltage conversion operation to provide an output voltage V_{OUT} to the IP block 30.

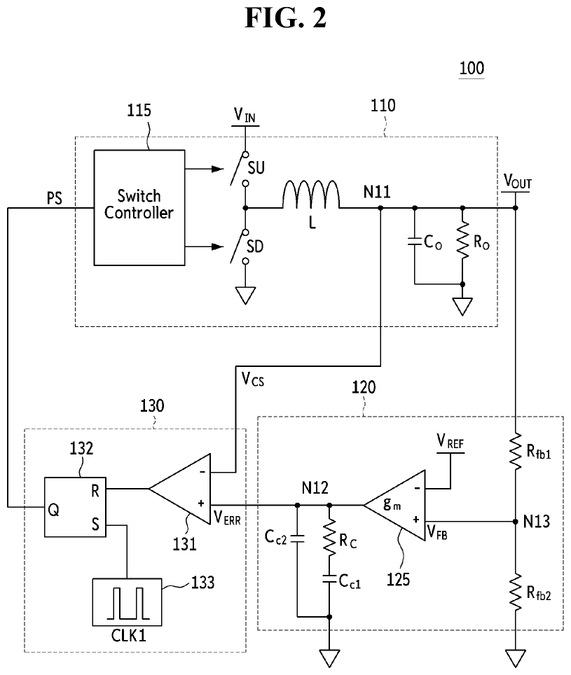

FIG. 2 is a circuit diagram illustrating a buck converter according to some embodiments.

Referring to FIG. 2, the buck converter 100 may include an output unit 110, a comparator 120, and a controller 130. Each of the output unit 110, the comparator 120, and the controller 130 may be a set of one or more circuits. The output unit 110 may include a switch controller 115, an inductor element L, an upper switch SU, and a lower switch SD. The upper switch SU may be implemented as a p-channel metal-oxide-semiconductor (PMOS) transistor, and the lower switch SD may be implemented as an n-channel metal-oxide-semiconductor (NMOS) transistor, but the disclosure is not limited thereto. The output unit 110 may generate the output voltage V_{OUT} from the input voltage V_{IN} based on a switching operation. The switching operation may include providing (or supplying) the input voltage V_{IN} to the inductor element L during a first time period and providing a ground voltage to the inductor element L during a second time period following the first time period. Accordingly, a current of the inductor element L may linearly increase during the first time period and linearly decrease during the second time period. The current of the inductor element L may have (or reach) a peak value at the end of the first time period. After the second time period ends, the first time period may follow (or begin) again. The current of the inductor element L may have a valley value at the end of the second time period.

The switch controller 115 may control the upper switch SU and the lower switch SD. For example, the switch controller 115 may receive a pulse width modulation (PWM) signal PS. The switch controller 115 may turn on the upper switch SU and turn off the lower switch SD during a logic high state of the PWM signal PS. The switch controller 115 may turn off the upper switch SU and turn on the lower switch SD during a logic low state of the PWM signal PS. To prevent a short circuit between the input voltage V_{IN} and the ground voltage, the switch controller 115 may set a time period/interval (referred to as a “dead time”) at which both the upper switch SU and the lower switch SD are turned off. When the upper switch SU is turned on, the upper switch SU may provide the input voltage V_{IN} to the inductor element L. When the lower switch SD is turned on, the lower switch SD may provide the ground voltage to the inductor element L.

The comparator 120 may include an error amplifier 125. The error amplifier 125 may receive a reference voltage V_{REF} through a first input terminal. The reference voltage V_{REF} may have a magnitude equivalent to a real number multiple of a target voltage V_{TAR}. A feedback voltage V_{FB} may be generated at an input node N13 of the error amplifier 125. According to a resistance ratio of feedback resistors R_{fb1} and R_{fb2}, the feedback voltage V_{FB} may have a magnitude equivalent to a real number multiple of the output voltage V_{OUT}. The error amplifier 125 may receive the feedback voltage V_{FB} generated at the input node N13 through a second input terminal. The error amplifier 125 may compare the reference voltage V_{REF} with the feedback voltage V_{FB} to output an error voltage V_{ERR}. The error voltage V_{ERR} may be determined based on a gain gₘ of the error amplifier 125, the reference voltage V_{REF}, and the feedback voltage V_{FB}. For example, the error voltage V_{ERR} may be proportional to a value obtained by multiplying the gain gₘ of the error amplifier 125 by a difference between the reference voltage V_{REF} and the feedback voltage V_{F}B. Several passive elements R_{C}, C_{C1} and C_{C2} may be connected to an output terminal of the error amplifier 125. The passive elements may delay voltage variations (e.g., the error voltage V_{ERR}) generated at the output terminal.

The controller 130 may include a comparison amplifier 131 and an RS flip-flop 132. The comparison amplifier 131 may receive the error voltage V_{ERR} through a first input terminal. For example, a sensing voltage V_{CS} may be generated at a node N11 connected to an end of the inductor element L in the output unit 110. The comparison amplifier 131 may receive the sensing voltage V_{CS} through a second input terminal. The comparison amplifier 131 may compare the sensing voltage V_{CS} with the error voltage V_{ERR} to output a comparison signal. For example, the comparison signal may be in a logic high state when the error voltage V_{ERR} is greater than the sensing voltage V_{CS}. The RS flip-flop 132 may receive a first clock signal CLK1 having a first period T_{S} from the comparison signal and the clock generator 133 to output the pulse width modulation (PWM) signal PS. For example, the PWM signal PS may be synchronized with a rising edge of the first clock signal CLK1 and synchronized with a falling edge of the comparison signal, but is not limited thereto.

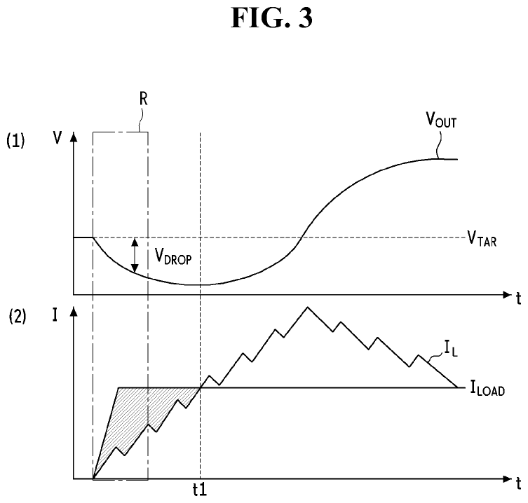

FIG. 3 is graphs illustrating a voltage drop occurring in a transient state.

A graph 1 (upper graph) of FIG. 3 represents a change in the output voltage V_{OUT} over time, and a graph 2 (lower graph) represents a change in a load current I_{LOAD} and an inductor current I_{L} over time. The inductor current I_{L} may be repeated to linearly increase and then decrease by the PWM signal PS. For example, the inductor current I_{L} may repeatedly rise and fall, and the average of the inductor current I_{L} may gradually increase and gradually decrease. In a steady state, in which the load current is constantly maintained, the reference voltage V_{REF} and the feedback voltage V_{FB} may have the same magnitude. For example, when the load current I_{LOAD} rapidly increases (or decreases), the load current I_{LOAD} may enter a transient state. Thus, a difference may occur between the reference voltage V_{REF} and the feedback voltage V_{FB}, and the error voltage V_{ERR} may also increase (or decrease). However, the passive elements of the output terminal of the error amplifier 125 may delay a change in the error voltage V_{ERR}. In the transient state, the error voltage V_{ERR} may not properly reflect the current load current I_{LOAD}, and the output unit 110 controlled by the PWM signal PS based on the error voltage V_{ERR} may not output charges corresponding to the current load current I_{LOAD}. When the charges corresponding to the current load current I_{LOAD} may not be output, the output voltage V_{OUT} may decrease compared to the target voltage V_{TAR}. A decrease in the output voltage (i.e., voltage drop V_{DROP}) may cause a malfunction of the IP block 30.

Referring to FIG. 3, an integral value of the load current I_{LOAD} over time in the graph 2 may correspond to the total amount of charges to be supplied. An integral value of the inductor current I_{L} over time may correspond to the amount of charges actually supplied by the output unit 110. Therefore, a hatched region may indicate the amount of insufficient charges that are not supplied to the IP block 30. Referring to Q=C·V, which is a formula for the relationship of voltage, capacitance, and the amount of charges, the voltage drop V_{DROP} as shown in the graph 1 may occur in the output voltage due to the amount of insufficient charges. A magnitude of the generated voltage drop V_{DROP} may be obtained or calculated by subtracting a magnitude of the output voltage V_{OUT} from a magnitude of the target voltage V_{TAR}.

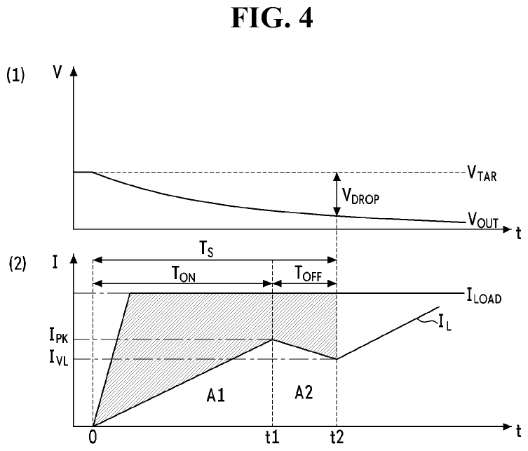

FIG. 4 is an enlarged view of a partial region R of FIG. 3 in order to estimate a load current.

Referring to FIG. 4, in the graph 2, the inductor current I_{L} may linearly increase and then linearly decrease during the first period T_{S}. For example, the inductor current I_{L} may linearly increase during a first time period T_{OFF} and linearly decrease during a second time period T_{OFF}. When the magnitude of the sensing voltage becomes equal to the magnitude of the error voltage, the first time period T_{OFF} may end, and the second time period T_{OFF} may begin. When the first time period T_{OFF} ends, the inductor current I_{L} may have a peak value I_{PK}. The end of the second time period T_{OFF} may be determined by the first period T_{S} (T_{OFF}=T_{S}−T_{ON}). When the second time period T_{OFF} ends, the inductor current I_{L} may have a valley value I_{VL}.

In the graph 1, the magnitude of the voltage drop V_{DROP} may be obtained or calculated by subtracting the magnitude of the output voltage V_{OUT} from the magnitude of the target voltage V_{TAR}. The magnitude of the amount of insufficient charges may be obtained through Q=C·V, which is a formula for the relationship of voltage, the amount of charges and capacitance.

Q_{drop}=C_{OUT}·V_{drop}=C_{OUT}·(V_{TAR}−V_{OUT})

For example, Q_{drop} may represent the amount of insufficient charges, C_{OUT} may represent an output capacitor (for example, the capacitor C_{O} of FIG. 2) of the buck converter, V_{drop} may represent the magnitude of the voltage drop at the end of the first period T_{S}, V_{TAR} may represent the magnitude of the target voltage, and V_{OUT} may represent the magnitude of the output voltage. The total amount of charges to be supplied may be obtained or calculated by adding the amount of charges actually supplied by the output unit 110 to the magnitude of the amount of insufficient charges.

Qₜₒₜₐₗ=Q_{drop}+A1+A2=C_{OUT}·(V_{TAR}−V_{OUT})+A1+A2

Qₜₒₜₐₗ may represent the total amount of charges to be supplied, and A1+A2 may represent the amount of charges actually supplied by the output unit 110 (e.g., an integral value with respect to time of the inductor current I_{L}). Assuming that the load current I_{LOAD} increases sufficiently fast, the magnitude of the load current I_{LOAD} may be approximated to a value obtained or calculated by dividing the total amount of charges to be supplied by the first period T_{S}. Therefore, the load current I_{LOAD} may be estimated as follows.

$${I}_{L O A D} = \frac{{Q}_{total}}{{T}_{S}} = \frac{{C}_{OUT} \cdot ( {V}_{TAR} - {V}_{OUT} )}{{T}_{S}} + \frac{A 1 + A 2}{{T}_{S}}$$

As described above, when the error voltage V_{ERR} may appropriately reflect the current load current I_{LOAD}, the voltage drop V_{DROP} may be prevented from occurring at the output voltage V_{OUT} in the transient state. According to some embodiments, an integrator circuit and an adder circuit may be further provided in the buck converter 100 so that the error voltage V_{ERR} may appropriately reflect the current load current I_{LOAD}, thereby alleviating the occurrence of the voltage drop V_{DROP}. This will be described later in more detail.

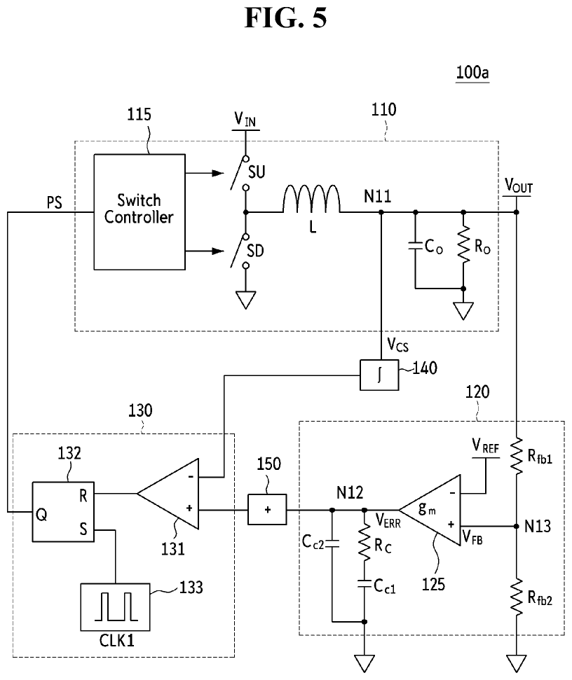

FIG. 5 is a circuit diagram illustrating a buck converter according to some embodiments.

Referring to FIG. 5, the buck converter 100a may include an output unit 110, a comparator 120, and a controller 130, in the same manner as the buck converter 100 of FIG. 2, and may further include an integrator circuit 140 and an adder circuit 150. The output unit 110 may include a switch controller 115, an inductor element L, an upper switch SU, and a lower switch SD. The output unit 110 may generate an output voltage V_{OUT} from an input voltage V_{IN} based on a switching operation. The switching operation may include providing the input voltage V_{IN} to the inductor element L during a first time period and providing a ground voltage to the inductor element L during a second time period following the first time period. Accordingly, the current of the inductor element L may linearly increase during the first time period and linearly decrease at the second time period. The current of the inductor element L may have a peak value at the end of the first time period. After the second time period ends, the first time period may follow (or begin) again. The current of the inductor element L may have a valley value at the end of the second time period.

The comparator 120 may include an error amplifier 125. The error amplifier 125 may receive a reference voltage V_{REF} through a first input terminal. The reference voltage V_{REF} may have a magnitude equivalent to a real number multiple of a target voltage V_{TAR}. A feedback voltage V_{FB} may be generated at an input node N13 of the error amplifier 125. According to a resistance ratio of feedback resistors R_{fb1} and R_{fb2}, the feedback voltage V_{FB} may have a magnitude equivalent to a real number multiple of the output voltage V_{OUT}. The error amplifier 125 may receive the feedback voltage V_{FB} generated at the input node N13 through a second input terminal. The error amplifier 125 may compare the reference voltage V_{REF} with the feedback voltage V_{FB} to output an error voltage V_{ERR}. Several passive elements R_{C}, C_{C1} and C_{C2} may be connected to an output terminal of the error amplifier 125.

The integrator circuit 140 may receive a sensing voltage V_{CS} and perform an integral operation based on the sensing voltage V_{CS} to provide an integral output to the controller 130. For example, the integrator circuit 140 may be connected between the inductor element L and the comparison amplifier 131 of the controller 130. The sensing voltage V_{CS} may be generated at a node N11 connected to an end of the inductor element L due to the inductor current I_{L} generated at the inductor element L. The integrator circuit 140 may receive the sensing voltage V_{CS} as an input, and may provide an integral output, which is obtained or calculated by integrating the sensing voltage V_{CS} with respect to time, to the controller 130. As a more detailed example, the integrator circuit 140 may receive the sensing voltage V_{CS} and provide an integral output, which is a result of integrating the sensing voltage V_{CS} with respect to time during the first period T_{S}, to the controller 130. In summary, the integral output that is an output of the integrator circuit 140 is as follows.

$${\int }_{0}^{{T}_{S}} {V}_{CS} \cdot dt$$

The integrator circuit 140 will be described later in more detail.

The adder circuit 150 may receive the error voltage V_{ERR} and perform an addition operation based on the error voltage V_{ERR} to provide an addition output to the controller 130. For example, the adder circuit 150 may receive the error voltage V_{ERR}, the reference voltage V_{REF}, and the feedback voltage V_{FB}, and may perform the addition operation based on the error voltage V_{ERR}, the reference voltage V_{REF}, and the feedback voltage V_{FB} to provide the addition output to the controller 130. The adder circuit 150 may be connected between the error amplifier 125 of the comparator 120 and the comparison amplifier 131 of the controller 130. The error voltage V_{ERR} may be generated at a node N12 connected to the output terminal of the error amplifier 125. The adder circuit 150 may receive the error voltage V_{ERR}, the reference voltage V_{REF}, and the feedback voltage V_{FB} as an input, and may provide the controller 130 with an addition output that is a result of adding an addition factor, which is determined by the reference voltage V_{REF} and the feedback voltage V_{FB}, to the error voltage V_{ERR}. As a more detailed example, the adder circuit 150 may receive the error voltage V_{ERR}, and may provide the controller 130 with an addition output obtained or calculated by adding an addition factor, which is a real number multiple of a value obtained or calculated by subtracting the feedback voltage V_{FB} from the reference voltage V_{REF}, to a value obtained or calculated by multiplying the error voltage V_{ERR} by the first period T_{S}. In summary, the addition output which is an output of the adder circuit 150 is as follows.

V_{ERR}·T_{S}+K_{C}·(V_{REF}−V_{FB})

The adder circuit 150 will be described later in more detail.

The controller 130 may include a comparison amplifier 131 and an RS flip-flop 132. The comparison amplifier 131 may receive the addition output from the adder circuit 150 through the first input terminal. The comparison amplifier 131 may receive an integral output from the integrator circuit 140 through the second input terminal. The comparison amplifier 131 may compare the addition output with the integral output to output a comparison signal. The comparison signal may be, for example, in a logic high state when the addition output is greater than the integral output. The RS flip-flop 132 may receive a first clock signal CLK1 having a first period T_{S} from the comparison signal and the clock generator 133 to output the PWM signal PS. For example, the PWM signal PS may be synchronized with a rising edge of the first clock signal CLK1 and synchronized with a falling edge of the comparison signal, but is not limited thereto.

In a steady state, the magnitude of the load current I_{LOAD} is an average value of the inductor current I_{L}. As described above, the load current may be estimated through the magnitude of the voltage drop in a transient state.

$${I}_{LOAD} = \frac{{Q}_{total}}{{T}_{S}} = \frac{{C}_{OUT} \cdot ( {V}_{TAR} - {V}_{OUT} )}{{T}_{S}} + \frac{A 1 + A 2}{{T}_{S}}$$

In a transient state, when the addition output is determined as a value obtained or calculated by adding the error voltage to a value obtained or calculated by adding a value of C_{OUT}·(V_{TAR}−V_{OUT})/T_{S} proportional to the voltage drop to the error voltage, the addition output may properly reflect the load current I_{LOAD} in the transient state. In other words, when the controller 130 determines the PWM signal PS in accordance with the following equation in the transient state, the voltage drop occurring in the output voltage V_{OUT} may be alleviated or reduced.

$${V}_{ERR} + \frac{{C}_{OUT} \cdot ( {V}_{TAR} - {V}_{OUT} )}{{T}_{S}} = \frac{1}{{T}_{S}} \cdot {\int }_{0}^{{T}_{S}} {V}_{C S} \cdot dt$$

Since the magnitude of the reference voltage V_{REF} is a real number multiple of the magnitude of the target voltage V_{TAR}, and the magnitude of the feedback voltage V_{FB} is a real number multiple of the magnitude of the output voltage V_{OUT}, the above equation may be summarized or rearranged as follows by multiplying both sides by T_{S}.

$${V}_{ERR} \cdot {T}_{S} + {K}_{C} \cdot ( {V}_{REF} - {V}_{FB} ) = {\int }_{0}^{{T}_{S}} {V}_{C S} \cdot dt$$

$${K}_{C} = α \cdot {C}_{OUT}$$

For example, α is a preset constant.

According to some embodiments, the integrator circuit 140 may receive a sensing voltage V_{CS} as an input value and output an integral output of

$${\int }_{0}^{{T}_{S}} {V}_{CS} \cdot dt$$

by performing an integral operation. According to some embodiments, the adder circuit 150 may receive the error voltage V_{ERR}, the reference voltage V_{REF}, and the feedback voltage V_{FB} as input values and output an addition output of V_{ERR}·T_{S}+K_{C}·(V_{REF}−V_{FB}) by performing the addition operation. The comparison amplifier 131 may receive the addition output of V_{ERR}·T_{S}+K_{C}·(V_{REF}−V_{FB}) from the adder circuit 150 through the first input terminal, and may receive the integral output of

$${\int }_{0}^{{T}_{S}} {V}_{CS} \cdot dt$$

from the integrator circuit 140 through the second input terminal. The controller 130 may output the pulse width control signal PS based on the addition output of V_{ERR}·T_{S}+K_{C}·(V_{REF}−V_{FB}) and the integral output of

$${\int }_{0}^{{T}_{S}} {V}_{CS} \cdot dt .$$

The output unit 110 may provide the IP block 30 with the output voltage V_{OUT} based on the pulse width control signal PS received from the controller 130.

According to some embodiments, the buck converter 100a may provide the IP block 30 with the output voltage V_{OUT} in which the voltage drop occurring in a transient state is alleviated or reduced. Therefore, a buck converter with improved stability and an electronic device including the buck converter may be provided.

According to some embodiments, the buck converter 100a may include a closed loop structure (e.g., feedback structure) to compensate for the voltage drop. As the buck converter 100a is implemented in a closed loop structure, unlike an open loop structure that uniformly compensates for the voltage drop, the voltage drop may not be overcompensated or undercompensated.

According to some embodiments, the buck converter 100a may not need to have an additional error amplifier with high power consumption to compensate for the voltage drop. As a result, a buck converter with improved power consumption and an electronic device including the buck converter may be provided.

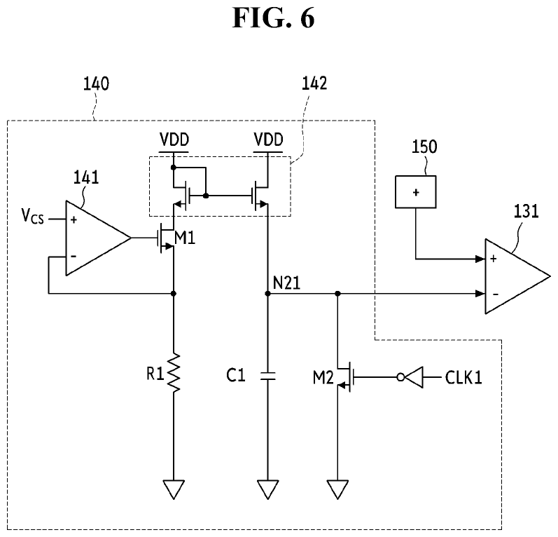

FIG. 6 is a circuit diagram illustrating an integrator circuit of a buck converter according to some embodiments.

Referring to FIG. 6, the integrator circuit 140 may include a buffer 141, a current mirror 142, transistors M1 and M2, a capacitor C1, and a resistor R1. The buffer 141 may receive the sensing voltage V_{CS} from the output unit 110 through a first input terminal. An output terminal of the buffer 141 may be connected to a gate terminal of the first transistor M1. A second input terminal of the buffer 141 may be connected between the first transistor M1 and the resistor R1. The current mirror 142 may copy a current flowing through the first transistor M1. Charges may be charged in a node N21 by the capacitor C1. A first clock signal CLK1 having a first period T_{S} may be provided to a gate terminal of the first transistor CLK1. The first clock signal CLK1 may discharge the charges charged in the node N21 every first period T_{S}. The integrator circuit 140 may provide the integral output of

$${\int }_{0}^{{T}_{S}} {V}_{CS} \cdot dt )$$

to the comparison amplifier 131 of the controller 130.

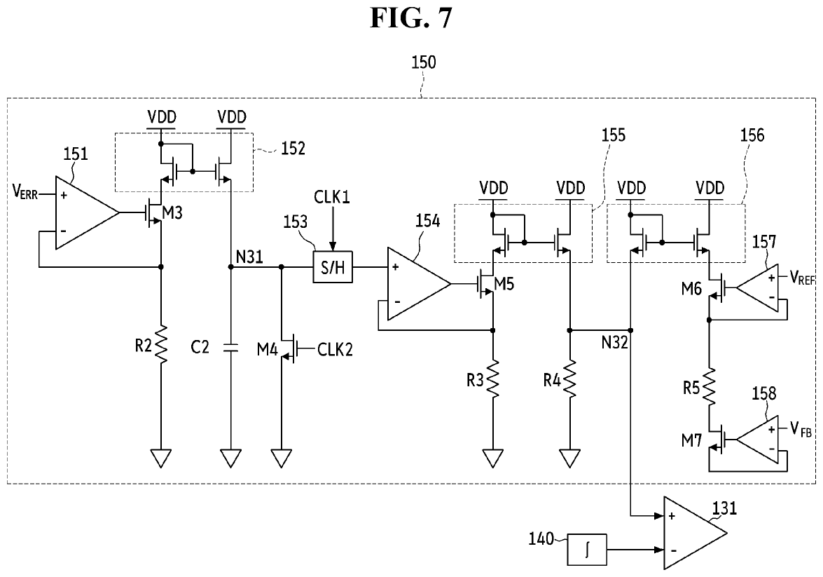

FIG. 7 is a circuit diagram illustrating an adder circuit of a buck converter according to some embodiments.

Referring to FIG. 7, the adder circuit 150 may include a sample and hold circuit 153, buffers 151, 154, 157 and 158, current mirrors 152, 155 and 156, transistors M3, M4, M5, M6 and M7, and passive elements R2, R3, R4 and R5. The first buffer 151 may receive the error voltage V_{ERR} from the comparator 120 through a first input terminal. An output terminal of the first buffer 151 may be connected to a gate terminal of the first transistor M3. A second input terminal of the first buffer 151 may be connected between the first transistor M3 and the first resistor R2. The first current mirror 152 may copy a current flowing through the first transistor M3. Charges may be charged in a first node N31 by the capacitor C2. A first clock signal CLK1 having a first period T_{S} may be provided to the sample and hold circuit 153. The sample and hold circuit 153 may sample a voltage charged in the first node N31 during the first period T_{S} at an interval of the first period T_{S} and provide the sampled voltage to the second buffer 154. A second clock signal CLK2 having a phase more delayed than the first clock signal CLK1 and having the first period T_{S} may be provided to a gate terminal of the second transistor M4. The second clock signal CLK2 may discharge charges charged in the first node N31 every first period T_{S}. The second buffer 154 may receive a sample voltage V_{ERR}·T_{S} from the sample and hold circuit 153.

The third buffer 157 may receive the reference voltage V_{REF} through a first input terminal, and the fourth buffer 158 may receive the feedback voltage V_{FB} through a first input terminal. The addition output of V_{ERR}·T_{S}+K_{C}·(V_{REF}−V_{FB}) may be generated at a second node N32 by the second and third current mirrors 155 and 156 and the second to fourth resistors R3, R4 and R5. The adder circuit 150 may provide the addition output of V_{ERR}·T_{S}+K_{C}·(V_{REF}−V_{FB}) to the comparison amplifier 131 of the controller 130.

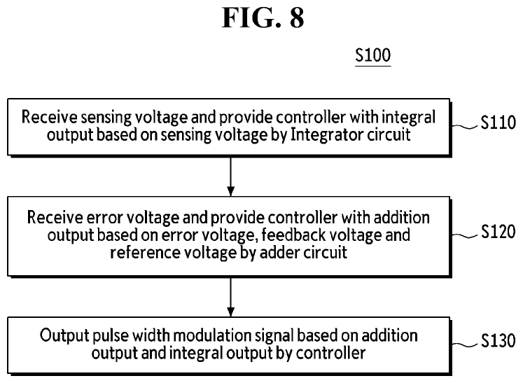

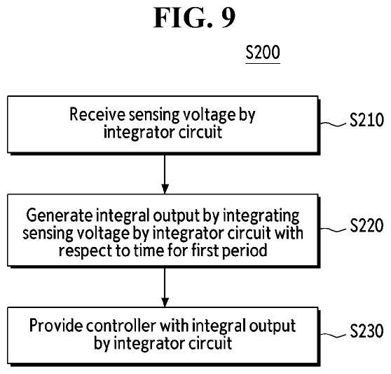

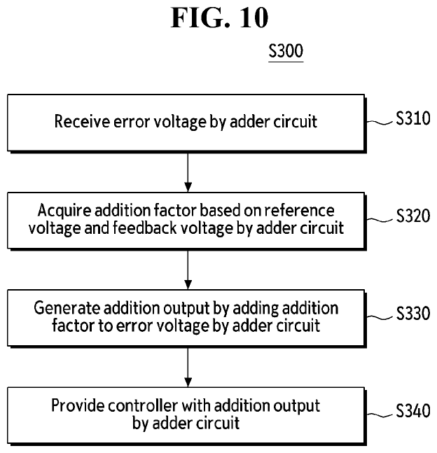

FIG. 8 is a flowchart illustrating a method for operating a buck converter of FIG. 5 according to some embodiments. FIG. 9 is a flowchart illustrating a method for operating an integrator circuit according to some embodiments. FIG. 10 is a flowchart illustrating a method for operating an adder circuit according to some embodiments.

Referring to FIGS. 5 and 8, a method S100 for operating a buck converter may include receiving a sensing voltage V_{CS} by the integrator circuit 140 and providing an integral output to the controller 130 based on the sensing voltage V_{CS} (S110). A method S200 for operating the integrator circuit will be described in more detail with reference to FIG. 9. The method S200 for operating the integrator circuit may include receiving the sensing voltage V_{CS} by the integrator circuit 140 (S210), outputting an integral output by integrating the sensing voltage V_{CS} for the first period T_{S} with respect to time (S220), and providing the integral output to the controller 130 (S230).

According to some embodiments, the method S100 for operating the buck converter may include receiving the error voltage V_{ERR} by the adder circuit 150 and providing the addition output to the controller 130 based on the error voltage V_{ERR}, the reference voltage V_{REF}, and the feedback voltage V_{FB}. The method S300 for operating the adder circuit will be described in more detail with reference to FIG. 10. The method S300 for operating the adder circuit may include receiving the error voltage V_{ERR} by the adder circuit 150, acquiring an addition factor based on the reference voltage V_{RE}F and the feedback voltage V_{FB} (S320), generating an addition output by adding the addition factor to the error voltage V_{ERR} (S330), and providing the addition output to the controller 130 (S340). In step S330, the adder circuit 150 may multiply the error voltage V_{ERR} by the first period T_{S} and generate the addition output by adding the addition factor to the multiplied result. For example, the addition factor may be determined as a real number multiple of a value obtained or calculated by subtracting a magnitude of the feedback voltage V_{FB} from a magnitude of the reference voltage V_{RE}F.

According to some embodiments, the method S100 for operating a buck converter includes outputting the PWM signal PS by the controller 130 based on the addition output and the integral output (S130). For example, the controller 130 may include a comparison amplifier 131 and an RS flip-flop 132. The comparison amplifier 131 may receive an addition output from the adder circuit 150 through a first input terminal. The comparison amplifier 131 may receive the integral output from the integrator circuit 140 through a second input terminal. The comparison amplifier 131 may compare the addition output with the integral output to output a comparison signal. For example, the comparison signal may be in a logic high state when the addition output is greater than the integral output. The RS flip-flop 132 may receive the comparison signal and a first clock signal CLK1 having a first period Ts to output the PWM signal PS based on the comparison signal and the first clock signal CLK1. For example, the PWM signal PS may be synchronized with a rising edge of the first clock signal CLK1 and synchronized with a falling edge of the comparison signal, but is not limited thereto.

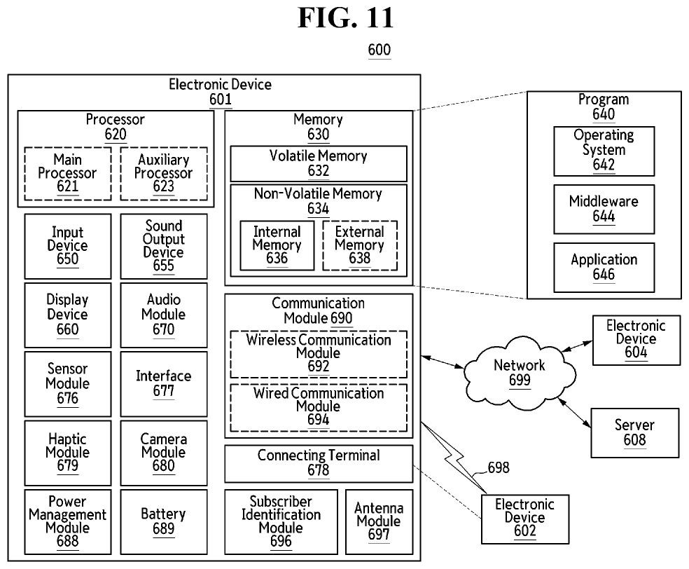

FIG. 11 is a block diagram illustrating an electronic device to which a buck converter according to some embodiments is applied.

Referring to FIG. 11, an electronic device 601 in a network environment 600 may communicate with an external electronic device 602 through a first network 698 such as a short-range wireless communication network, or may communicate with an external electronic device 604 or a server 608 through a second network 699 such as a long-range wireless communication network. In some embodiments, the electronic device 601 may be, for example, a notebook computer, a laptop computer, a portable mobile terminal, etc., but the embodiments are not limited thereto.

The electronic device 601 may perform communication with the external electronic device 604 through the server 608. The electronic device 601 may include a processor 620, a memory 630, an input device 650, a sound output device 655, a display device 660, an audio module 670, a sensor module 676, an interface 677, a connecting terminal 678, a haptic module 679, a camera module 680, a power management module 688, a battery 689, a communication module 690, a subscriber identification module (SIM) 696, or an antenna module 697.

In some embodiments, at least one of the components such as the display device 660 or the camera module 680 may be omitted from the electronic device 601, or one or more additional components may be added to the electronic device 601.

In some embodiments, some components may be integrated into a single integrated circuit (IC). For example, the sensor module 676 such as a fingerprint sensor, an iris sensor and an illuminance sensor may be embedded in the display device such as a display.

The processor 620 may perform a variety of data processing or computations by executing software (e.g., program 640) for controlling other components of at least one electronic device 601 such as hardware or software components connected to the processor 620.

As at least part of data processing or computations, the processor 620 may load commands or data received from another component such as the sensor module 676 or the communication module 690 in a volatile memory 632, process the commands or data stored in the volatile memory 632 and store the result data in a non-volatile memory 634.

The processor 620 may include a main processor 621 such as a central processing unit (CPU) or an application processor (AP), and an auxiliary processor 623, which is operated independently of the main processor 621 or operated as being associated with the main processor 621.

The auxiliary processor 623 may include, for example, a graphics processing unit (GPU), an image signal processor (ISP), a sensor hub processor or a communication processor (CP).

In some embodiments, the auxiliary processor 623 may be configured to consume less power than the main processor 621 or to execute a particular function. The auxiliary processor 623 may be implemented separately from the main processor 621 or implemented as part of the main processor 621.

The auxiliary processor 623 may control at least some of functions or states related to at least one of the components of the electronic device 601 on behalf of the main processor 621 while the main processor 621 is inactive or in conjunction with the main processor 621 while the main processor 621 is active.

The memory 630 may store various data used by at least one component of the electronic device 601. The data may include, for example, the program 640, as well as input data and output data for commands related to the software. The memory 630 may include a volatile memory 632 or a non-volatile memory 634.

The program 640 may be stored in the memory 630 as software, and may include, for example, an operating system (OS) 642, a middleware 644, and/or an application 646.

The input device 650 may receive commands or data to be used for another component of the electronic device 601 from the outside of the electronic device 601. The input device 650 may include, for example, a microphone, a mouse, and/or a keyboard.

The sound output device 655 may output a sound signal to the outside of the electronic device 601. The sound output device 655 may include, for example, a speaker. Multimedia data may be output through the speaker.

The display device 660 may visually provide information to the outside of the electronic device 601. The display device 660 may include, for example, a display, a hologram device or a projector, and a control circuit for controlling a corresponding one of the display, the hologram device and/or the projector.

In some embodiments, the display device 660 may include a touch circuit configured to sense a touch, or a sensor circuit, such as a pressure sensor, configured to measure the strength of a force generated by the touch.

The audio module 670 may convert sound into an electrical signal, or vice versa. In some embodiments, the audio module 670 may obtain sound via the input device 650, or may output sound via the sound output device 655 or a headphone of the external electronic device 602 directly or wirelessly connected to the electronic device 601.

The sensor module 676 may detect an operating state (e.g., power or temperature) of the electronic device 601 or an external environmental state (e.g., user state) of the electronic device 601, and may generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 677 may support one or more prescribed protocols to be used by the electronic device 601, which is directly or wirelessly connected to the external electronic device 602. In some embodiments, the interface 677 may include, for example, a high definition multimedia interface (HDMI), a universal serial bus (USB) interface, a secure digital (SD) card interface, and/or an audio interface.

The connecting terminal 678 may include a connector through which the electronic device 601 may be physically or electrically connected to the external electronic device 602. In some embodiments, the connecting terminal 678 may include, for example, an HDMI connector, a USB connector, an SD card connector, and/or an audio connector (e.g., a headphone connector).

The haptic module 679 may convert an electrical signal into a mechanical stimulus, such as vibration or motion, which is recognized by a user, through a tactile sensation or a kinesthetic sensation. In some embodiments, the haptic module 679 may include, for example, a motor, a piezoelectric element, and/or an electrical stimulator.

The camera module 680 may capture a still image and motion images. In some embodiments, the camera module 680 may include one or more lenses, an image sensor, an image signal processor, and/or a flash.

The battery 689 may supply power to at least one component of the electronic device 601. According to one embodiment, the battery 689 may include, for example, a non-rechargeable primary battery, a rechargeable secondary battery, and/or a fuel cell.

The power management module 688 may manage the power supplied to the electronic device 601. For example, the power management module 688 may be implemented as at least part of a power management integrated circuit (PMIC).

The communication module 690 may support a direct communication channel or a wireless communication channel between the electronic device 601 and the external electronic device (e.g., the electronic device 602, the external electronic device 604, and/or the server 608), and may perform communication through the established communication channel.

The communication module 690 may include one or more communication processors that operate independently of the processor 620 and support direct communication or wireless communication.

In some embodiments, the communication module 690 may include a wireless communication module 692 such as a cellular communication module, a short-range wireless communication module or a global navigation satellite system (GNSS) communication module, and/or a wired communication module 694 such as a local area network (LAN) communication module or a power line communication (PLC) module.

A corresponding communication module of these communication modules may perform communication with the external electronic device via the first network 698 (e.g., Bluetooth™, wireless fidelity (Wi-Fi) Direct, or standard of the Infrared Data Association (IrDA)) or the second network 699 (e.g., a mobile communication network, Internet, a long-range communication network, etc.).

These various types of communication modules may be implemented as a single component, or may be implemented as a plurality of components separated from each other. The wireless communication module 692 may identify or authenticate the electronic device 601 within a communication network, such as the first network 698 or the second network 699, using subscriber information (e.g., International Mobile Subscriber Identity (IMSI)) stored in the subscriber identification module 696.

The antenna module 697 may transmit or receive a signal or power to or from outside the electronic device 601. In some embodiments, the antenna module 697 may include one or more antennas, and the communication module 690 may select at least one antenna, which is suitable for a communication scheme used in the communication network, such as the first network 698 or the second network 699. Then, a signal or power may be transmitted or received between the communication module and the external electronic device via the selected antenna.

Some components described above may be interconnected to exchange signals therebetween using an inter-peripheral communication scheme such as bus, general purpose input and output (GPIO), serial peripheral interface (SPI) and mobile industry processor interface (MIPI).

In some embodiments, commands or data may be transmitted or received between the electronic device 601 and an external electronic device 606 via the server 608 connected to the second network 699. The external electronic devices 602 and 606 may be the same type of devices as, or different types of devices from, the electronic device 601. All or some of the operations to be executed in the electronic device 601 may be executed in one or more external electronic devices 602, 606, and/or 608.

For example, when the electronic device 601 needs to perform functions or services automatically or in response to a request from a user or another device, the electronic device 601 may request one or more external electronic devices to perform at least part of the functions or services additionally or instead of executing the functions or services. The one or more external electronic devices that receive the request may execute at least part of the requested functions or services, or an additional function or service associated with the request, and may forward the execution result to the electronic device 601. The electronic device 601 may provide the result as at least part of the response to the request with or without additional process of the result. For example, cloud computing, distributed computing or client-server computing technologies may be used.

According to some embodiments, the electronic device 601 may correspond to the electronic device 1 described with reference to FIG. 1. The power management module 688 may be implemented as the integrated circuit 20 described with reference to FIG. 1. The power management module 688 may include the buck converter 100a described with reference to FIG. 5. The battery 689 may be implemented as part of the power supply device 10 described with reference to FIG. 1. The IP block 30 described with reference to FIG. 1 may be implemented as the processor 620, the memory 630, the input device 650, the sound output device 655, the display device 660, the audio module 670, the sensor module 676, the interface 677, the haptic module 679, the camera module 680, the power management module 688, the battery 689, the communication module 690, the subscriber identification module (SIM) 696 or the antenna module 697 in the electronic device 601, but is not limited thereto.

According to some embodiments, the battery 689 may provide an input voltage to the power management module 688. The DC-DC converter in the power management module 688 may receive the input voltage from the battery 689 and provide an output voltage obtained by reducing the input voltage to the processor 620, the memory 630, the input device 650, the sound output device 655, the display device 660, the audio module 670, the sensor module 676, the interface 677, the haptic module 679, the camera module 680, the power management module 688, the battery 689, the communication module 690, the subscriber identification module (SIM) 696, and/or the antenna module 697.

According to some embodiments, the buck converter of the power management module 688 may provide the processor 620, the memory 630, the input device 650, the sound output device 655, the display device 660, the audio module 670, the sensor module 676, the interface 677, the haptic module 679, the camera module 680, the power management module 688, the battery 689, the communication module 690, the subscriber identification module (SIM) 696, and/or the antenna module 697 with the output voltage in which voltage drop occurring in a transient state is alleviated or reduced. Accordingly, the electronic device 601 may have improved operational stability may be provided.

Although some embodiments of the disclosure have been described above with reference to the accompanying diagrams, the disclosure may not be limited to some embodiments and may be implemented in various different forms. It will be appreciated that the disclosure may be implemented in other specific forms without changing the technical idea or essential features of the disclosure. Therefore, it should be understood that some embodiments as described above are not restrictive but illustrative in all respects.

What is claimed is:

1. A buck converter comprising:
an output circuit including an inductor and a switch controller configured to control a current of the inductor based on a pulse width modulation signal;
a comparator configured to output an error voltage based on a reference voltage and a feedback voltage;
an integrator circuit configured to receive a sensing voltage generated at an end of the inductor and output an integral output based on the sensing voltage;
an adder circuit configured to receive the error voltage and output an addition output based on the error voltage, the feedback voltage, and the reference voltage; and
a controller configured to output the pulse width modulation signal by comparing the integral output with the addition output.

2. The buck converter of claim 1, wherein the integrator circuit is configured to output the integral output by integrating the sensing voltage with respect to time for a first period.

3. The buck converter of claim 1, wherein the adder circuit is configured to output the addition output by adding an addition factor determined based on the feedback voltage and the reference voltage to the error voltage.

4. The buck converter of claim 3, wherein the addition factor is determined by a real number multiple of a value obtained by subtracting a magnitude of the feedback voltage from a magnitude of the reference voltage.

5. The buck converter of claim 3, wherein the adder circuit is configured to output the addition output by multiplying the error voltage by a first period and adding the addition factor determined based on the feedback voltage and the reference voltage to the multiplied result.

6. The buck converter of claim 1, wherein the comparator includes a first feedback resistor, a second feedback resistor, and an error amplifier, and wherein the error amplifier is configured to output the error voltage by receiving the reference voltage and the feedback voltage.

7. The buck converter of claim 6, wherein the feedback voltage is determined based on a resistance ratio of the first and second feedback resistors and the output voltage.

8. The buck converter of claim 1, wherein the controller includes a comparison amplifier and an RS flip-flop,
wherein the comparison amplifier is configured to compare the integral output with the addition output to output a comparison signal, and
wherein the RS flip-flop is configured to receive the comparison signal and a first clock signal having a first period and to output the pulse width modulation signal based on the comparison signal and the first clock signal.

9. A method for operating a buck converter, the method comprising:
receiving a sensing voltage generated at an end of an inductor and providing a controller with an integral output based on the sensing voltage by an integrator circuit;
receiving an error voltage and providing the controller with an addition output based on the error voltage, a feedback voltage and a reference voltage by an adder circuit; and
comparing the integral output with the addition output by the controller to output a pulse width modulation signal.

10. The method of claim 9, wherein the providing the controller with the integral output based on the sensing voltage by the integrator circuit comprises providing the controller with the integral output by integrating the sensing voltage by the integrator circuit with respect to time for a first period.

11. The method of claim 9, wherein the providing the controller with the addition output based on the error voltage, the feedback voltage and the reference voltage by the adder circuit comprises providing the controller with the addition output by adding an addition factor determined based on the feedback voltage and the reference voltage to the error voltage by the adder circuit.

12. The method of claim 11, wherein the addition factor is determined by a real number multiple of a value obtained by subtracting a magnitude of the feedback voltage from a magnitude of the reference voltage.

13. The method of claim 11, wherein the providing the controller with the addition output by adding the addition factor to the error voltage by the adder circuit comprises providing the controller with the addition output by multiplying the error voltage by a first period and adding the addition factor to the multiplied result by the adder circuit.

14. The method of claim 9, further comprising providing the adder circuit with the error voltage based on the reference voltage and the feedback voltage by a comparator.

15. The method of claim 14, wherein the feedback voltage is determined based on a resistance ratio of the first and second feedback resistors and the output voltage.

16. The method of claim 9, wherein the comparing the integral output with the addition output by the controller to output the pulse width modulation signal comprises:
comparing the integral output with the addition output to output a comparison signal by a comparison amplifier of the controller, and
receiving the comparison signal and a first clock signal having a first period by an RS flip-flop of the controller and outputting the pulse width modulation signal based on the comparison signal and the first clock signal.

17. An electronic device comprising:
a power supply device configured to output an input voltage;
an integrated circuit including a buck converter configured to receive the input voltage and output an output voltage by stepping down the input voltage; and
one or more IP blocks configured to receive the output voltage,
wherein the buck converter comprises:
an output circuit including an inductor and a switch controller configured to control a current of the inductor based on a pulse width modulation signal,
a comparator configured to output an error voltage based on a reference voltage and a feedback voltage,
an integrator circuit configured to receive a sensing voltage generated at an end of the inductor and output an integral output based on the sensing voltage,
an adder circuit configured to receive the error voltage and output an addition output based on the error voltage, the feedback voltage, and the reference voltage, and
a controller configured to output the pulse width modulation signal by comparing the integral output with the addition output.

18. The electronic device of claim 17, wherein the integrator circuit is configured to output the integral output by integrating the sensing voltage with respect to time for a first period.

19. The electronic device of claim 17, wherein the adder circuit is configured to output the addition output by adding an addition factor determined based on the feedback voltage and the reference voltage to the error voltage.

20. The electronic device of claim 19, wherein the addition factor is determined by a real number multiple of a value obtained by subtracting a magnitude of the feedback voltage from a magnitude of the reference voltage.
